(19) United States
(12) Patent Application Publication
(10) Pub. No.: US 2022/0271380 A1
(43) Pub. Date: Aug. 25, 2022

(54) BATTERY DEVICE

(71) Applicant: MAHLE International GmbH, Stuttgart (DE)

(72) Inventors: Michael Kranich, Gemmrigheim (DE); Heiko Neff, Auenwald (DE); Carolin Vesenmaier, Rottenburg (DE); Walter Wolf, Oppenweiler-Zell (DE)

(21) Appl. No.: 17/680,268

(22) Filed: Feb. 24, 2022

(30) Foreign Application Priority Data
Feb. 24, 2021 (DE) 10 2021 201 739.8

(51) Int. Cl. H01M 50/26; H01M 10/6557; H01M 10/647; H01M 10/6568; H01M 50/209

(52) U.S. Cl. CPC H01M 50/26; H01M 10/6557; H01M 10/647; H01M 10/6568; H01M 50/209

(57) ABSTRACT

A battery device is provided which includes a cell stack of rechargeable individual battery cells which are touchingly stacked and clamped to one another in a stack direction, in particular so-called hard case battery cells, wherein on at least one mounting surface of a cell housing of a respective individual battery cell including mounting surfaces that are arranged rectangularly, at least one separate channel web for forming a liquid channel that can be flowed through is arranged. At least one of the respective channel webs is touchingly fixed in a firmly bonded manner to the respective mounting surface by bonding, practically with web adhesive.

### CROSS REFERENCE TO RELATED APPLICATIONS

This application claims priority to German patent application DE 10 2021 201 739.8, filed Feb. 24, 2021, the entire content of which is incorporated herein by reference.

### TECHNICAL FIELD

The disclosure relates to a battery device and to a method for producing such a battery device.

### BACKGROUND

Practically, individual battery cells of battery devices of this type are mutually clamped to one another in a stack direction via an anchor bolt in order to provide a firmly contiguous cell stack, quasi an individual battery cell composite of individual battery cells that are mutually non-displaceable. In order to temperature-control the individual battery cells as desired, liquid channels that can be flowed through are provided between the respective individual battery cells in the stack direction. For example, the document DE 10 2011 013618 A1 describes a battery device having a plurality of individual battery cells of a clamping device for clamping the individual battery cells to one another, and a temperature-control device for temperature-controlling the individual battery cells. The clamping device is configured as a functional part of the temperature-control device. Further, the document DE 60001887 T2 describes a battery device which is formed by connecting a plurality of rechargeable individual battery cells, wherein a plurality of prismatic cell housing components are provided, which are each made of resin and comprise short side walls and long side walls. The known battery devices, because of the plurality of battery device components, are relatively large constructions with a relatively large own weight, although compact and light battery devices are desirable.

### SUMMARY

It is therefore an object of the disclosure to provide an improved or at least another embodiment of a battery device.

This object is achieved by a battery device and a method for producing a battery device as described herein.

A basic idea of the disclosure consists in optimizing battery devices through function integration with respect to installation space requirement and total weight.

Specifically, a battery device having a cell stack of rechargeable individual battery cells which are touchingly stacked and clamped to one another is provided so-called hard case battery cells or alternatively pouch cells. Such battery devices can typically be employed for mobile applications, as traction battery device for a motor vehicle. On at least one mounting surface of a cell housing of a respective individual battery cell comprising mounting surfaces arranged rectangularly at least one separate channel web for forming a liquid channel that can be flowed through is arranged. At least one of the respective channel webs is touchingly fixed to the respective mounting surface in a firmly bonded manner, practically with a web adhesive. This has the effect that the liquid channels formed with the help of the channel webs for conducting liquid for cooling and/or for heating the respective individual battery cell can be directly fixed to the cell housings of the respective individual battery in order to achieve in particular a better thermal efficiency as a consequence of a direct heat energy transfer from the individual battery cell to the respective liquid. Further heat transfer components are not required. The battery device can therefore be embodied so as to be comparatively compact and relatively light. As liquid, a cooling liquid can be used for example. “Clamped individual battery cells” among experts means individual battery cells mutually subjected to pressure force with anchor bolts or the like in the stack direction, i.e., clamped or compressed individual battery cells.

Further practically, at least one of these channel webs can be at least partially formed by a web adhesive and be stable in shape in the hardened state of the web adhesive. This means that at least one of the channel webs can be practically formed completely by a web adhesive. In particular, the web adhesive can be applied to the respective mounting surface of the respective cell housing with a multi-axis application robot. This has the effect that because of the contour-independent applicability of the web adhesive, any shapes of the respective channel webs or of the liquid channels formed from these are possible. This has the advantage that the liquid conduction within the respective liquid channels can be optimized. The shape stability of the hardened web adhesive brings about that the channel webs formed of web adhesive can be subjected to clamping force above all in the direction of the stack direction and transversely thereto, without these substantially deforming elastically or deforming plastically in the direction of the stack direction and/or transversely thereto.

Naturally, the said channel webs can also be formed by way of prefabricated finished web parts, which are bonded to one or more mounting surfaces of the individual battery cells. These finished web parts can have grooves and/or recesses which can be filled with adhesive and/or adhesive sealant, quasi an adhesive slot. In order for the channel webs or channel web patterns to be stable in shape, these can contain connecting webs transversely to the flow direction, which have a lower height than the channel webs. However, the free application of the web adhesive is preferred. By way of this, expensive molds and additional handling operations can be omitted.

Practically, the web adhesive forming the respective channel webs can originate from the group of thixotropic adhesives, and/or have thixotropic properties. Thixotropic adhesives have thixotropic properties, so that the flow properties of these are time-dependent and load-dependent. Practically, thixotropic adhesives retain their shape when applied to the respective mounting surface over a certain period of time unchanged, they are thus stable in shape or inherently stable, which simplifies the applicability of the web adhesive or of the already sophisticated adhesive application as a whole. Following the hardening, thixotropic adhesives are practically solid and likewise stable in shape.

Further practically, at least one spacer can be arranged on at least one mounting surface of the respective cell housing of the respective individual battery cell equipped with at least one channel web of web adhesive. Beside the respective at least one channel web, the spacer has a force-supporting effect in the stack direction. Accordingly, a separate or integral spacer can also be provided beside a channel web on at least one mounting surface of a cell housing. Channel web and spacer can also be embodied integrally. This has the effect that for example during the clamping of the individual battery cells to form the common cell stack, clamping forces that occur can be separated, so that the pro-rated force flows through the at least one channel web and through the at least one spacer. This has the advantage that the respective channel webs are less force-loaded or that the cell stack can be clamped with greater clamping force in the stack direction, as a result of which the same is more stable for example.

Practically, at least one filler can be admixed or added to the respective web adhesive, in particular glass spheres or other fillers or further fillers. By admixing fillers to the web adhesive in particular the viscosity and/or the durability of the web adhesive can be positively influenced. Admixed glass spheres or hollow glass spheres can positively influence for example the force transmission within the web adhesive, quasi at a microscopic level. Because of this, the web adhesive can be advantageously formed stable in shape.

Practically it is provided, furthermore, to form in the stack direction between at least two cell housings of two separate individual battery cells, at least one liquid channel that can be flowed through for conducting liquid, in order to either cool or heat the individual battery cells according to choice.

Further practically, at least two separate individual battery cells of the cell stack can be indirectly touchingly stacked to one another in the stack direction via a single channel web, wherein the respective channel web forms or delimits at least one sole liquid channel for conducting liquid. Here, the respective channel web can be fixed to the cell housing, in particular to the mounting surface of the same of the one respective individual battery cell or to the cell housing, in particular to the mounting surface of the same, of the other respective individual battery cell. Because of this, liquid can flow between the two separate individual battery cells of the cell stack, in particular transversely to the stack direction, in order to transfer heat energy from the individual battery cells to the liquid or vice versa. This has the advantage that the battery device can be cooled or heated as desired.

Practically, at least two separate individual battery cells of the cell stack can be indirectly touchingly stacked to one another in the stack direction via two channel webs. Here, these two channel webs jointly form or delimit at least one liquid channel for conducting liquid, wherein the one channel web is fixed to the cell housing, in particular to the mounting surface of the same, of the one respective individual battery cell and the other channel web to the cell housing, in particular to the mounting surface of the same, of the other respective individual battery cell. Alternatively or additionally, a liquid channel formed of channel webs for conducting liquid can be formed or delimited in the stack direction between at least one cell housing of an individual battery cell of the cell stack and an end plate arranged on the cell stack at the front face. By way of this, liquid can also flow between the two separate individual battery cells of the cell stack and/or between an individual battery cell and an end plate attached thereto, in particular transversely to the stack direction, in order to transfer heat energy from the individual battery cells to the liquid or vice versa. This has the advantage in particular that the battery device can be cooled or heated as desired.

Further practically, at least two separate individual battery cells of the cell stack can be indirectly touchingly stacked to one another in the stack direction via channel webs, wherein the respective channel webs form or delimit at least one liquid channel for conducting liquid. Further channel webs can form or delimit at least one collection channel for discharging and supplying liquid to at least one respective liquid channel. Because of this, each individual battery cell is quasi equipped with at least one liquid channel, wherein the respective liquid channel can be advantageously supplied with liquid with a collection channel.

Practically, at least one liquid channel can comprise meander-shaped channel loops, wherein at least one channel loop has meander long arms and an arc-shaped meander short arm interconnecting these so as to communicate fluidically. Here, the respective meander long arms are oriented transversely with respect to the stack direction, wherein the respective meander short arm is oriented transversely with respect to the stack direction and the meander long arms. Furthermore, the respective meander short arm can extend maximally over 30% of a total length of a meander long arm. This has the advantageous effect that the heat energy transfer between individual battery cell and liquid is improved. Practically, a meander long arm is greater with respect to its total length than the total length of a meander short arm.

Further practically, at least one liquid channel and/or at least one collection channel can be delimited or bordered by at least one channel web or a pair of channel webs transversely with respect to the stack direction, in order to conduct liquid for cooling or heating of the individual battery cells. This has the advantageous effect that a liquid can be conducted through the battery device.

Practically, at least one mounting surface of the respective cell housing designated as liquid channel mounting surface can be oriented perpendicularly or substantially perpendicularly with respect to the stack direction. Here, “substantially perpendicularly” can mean that round about the perpendicular, a deviation for example of +/−5° is possible within the scope of a tolerance band. Furthermore, the respective cell housing can comprise two liquid channel mounting surfaces located opposite one another and oriented parallel to one another. Here, at least one channel web is fixed to each of the respective liquid channel mounting surfaces. Because of this, the respective cell housing comprises two mounting surfaces located opposite, each of which is equipped or can be equipped with at least one channel web. This has the advantage that further cell housings can be placed against the respective cell housing, quasi from both sides. Alternatively, it is conceivable that the respective cell housing comprises two liquid channel mounting surfaces that are located opposite one another and oriented parallel to one another, wherein on the one liquid channel mounting surface at least one channel web is touchingly fixed, while the other liquid channel mounting surface is configured channel web-free. Because of this, merely a single one of the two mounting surfaces is equipped with a channel web. This also has the advantage that further cell housings can be placed against the cell housing, for example in that a first cell housing with its respective mounting surface with a channel web is placed against a channel web-free mounting surface of a second cell housing.

Further practically, at least one mounting surface of the respective cell housing designated as collection channel mounting surface can be oriented parallel or substantially parallel with respect to the stack direction, wherein at least one collection channel mounting surface of the respective cell housing is arranged at a right angle with respect to a liquid channel mounting surface of the respective cell housing. Here it is also possible practically to imagine angular arrangements as well. At any rate, an advantageous configuration of the battery device can be realized by way of this.

Practically, channel webs can each be arranged on at least one liquid channel mounting surface and on at least one collection channel mounting surface each. Here, the channel webs arranged on the liquid channel mounting surfaces can form or delimit liquid channels for conducting liquid, wherein the channel webs arranged on the collection channel mounting surfaces form or delimit collection channels for discharging and supplying liquid to at least one of the liquid channels.

Further practically, at least one or all liquid channels and one or all collection channels are configured so that they can be flowed through by liquid transversely with respect to the stack direction, so that the respective adjoining individual battery cells can be cooled and/or heated.

Further practically, at least one collection channel for discharging and supplying liquid can be connected to at least one liquid channel so as to communicate fluidically. By way of this, quasi a liquid system that can be flowed through by liquid is stated, with which the battery device can be cooled and/or heated as desired. Practically, at least one or all collection channels are configured so that they can be flowed through by liquid longitudinally with respect to the stack direction and are connected to at least one or all liquid channels so as to communicate fluidically. By way of this, mainly the liquid channels that are connected to the collection channels so as to communicate fluidically can be supplied with liquid. Further, a cooling and/or a heating of the respective adjoining individual battery cells can be realized with the collection channels flowed through by liquid.

It is practical, furthermore, when a collection channel is configured as supply channel for supplying liquid to one or all liquid channels and a further collection channel as discharge channel for discharging liquid from one or all liquid channels. It can be imagined for example to connect a supply line to the supply channel and a discharge line to the discharge channel so that liquid during the operation of the battery device emanating from the supply line can initially flow, through the supply channel to the liquid channels. After the liquid has flowed through the meandering channel loops of the respective liquid channels there quasi in a heat energy-transferring manner, it can, flowing backwards, enter the discharge channel and the discharge line in order to flow out there. Thus, the practical work with the battery device can be favored.

Practically, the disclosure provides a method for producing a battery device, in particular a battery device. A corresponding method initially comprises at least two individual battery cells that can each be recharged. Further, the following steps are carried out:

1a) Applying an adhesive forming an adhesive bead in particular of a web adhesive from the group of the thixotropic adhesives to a mounting surface of a first individual battery cell with the help of an application robot or as part of a screen print or as part of a stencil print with guide stencils. Alternatively, this can be followed by:

1b) Applying an adhesive enriched with fillers and forming an adhesive bead, in particular a web adhesive from the group of the thixotropic adhesives to a mounting surface of a first individual battery cell with the help of an application robot or as part of a screen print or as part of a stencil print with guide stencils. Alternatively or additionally, this can then be followed by:

2a) Applying an adhesive forming an adhesive bead, in particular of a web adhesive from the group of the thixotropic adhesives to a mounting surface of a second individual battery cell with the help of an application robot or as part of a screen print or as part of a stencil print with guide stencils. Alternatively, this can be subsequently followed by:

2b) Applying an adhesive enriched with fillers and forming an adhesive bead, in particular of a web adhesive from the group of the thixotropic adhesives to a mounting surface of a second individual battery cell with the help of an application robot or as part of a screen print or as part of a stencil print with guide stencils. Further:

3) Hardening of the respective adhesive in order to form channel webs out of the applied adhesive beads that are stable in shape. Further:

4) Stacking the individual battery cells onto one another in a stack direction, wherein the channel webs of the first individual battery cell each touchingly support themselves on the channel webs of the second individual battery cell in order to form in the stack direction between the two individual battery cells liquid channels that can be flowed through by liquid for the purpose of individual battery cell temperature control. By way of this, a favourable method for providing a battery device is provided.

Optionally, as a Step 3a) to be carried out between Steps 3) and 4) it can be provided: following the hardening of the respective adhesives forming the channel webs, applying a further adhesive onto these hardened channel webs, wherein these are then stacked to one another according to Step 4) in order to pre-fix the cell stacks and in order to keep these tight, even upon a loss of or reduced preload of the stacked individual battery cells.

Optionally, the individual battery cells can be directly stacked to one another, i.e., without unnecessary time delay after the application of the web adhesive beads or of the web adhesive. By way of this, the two-time application of adhesive is not required. Further, pre-fixed and tight stacks of individual battery cells with or without connecting plates can thereby be realized. Here or generally, the adhesive is practically adjusted so that it is not or practically not or not too much compressed under the weight of the individual battery cells that are stacked to one another. Optionally, an adhesive bead can also be higher than the channel height desired later on, wherein the channel height is then adjusted if required by spacers, as a result of which channel heights with reproducible, close tolerances can be realized.

Practically, a said liquid channel has an inlet for liquid and an outlet for liquid. The inlet and the outlet of a liquid channel or the inlets and the outlets of multiple liquid channels can be arranged in various positions on a respective individual battery cell or the battery device, for example so that the inlet and outlet of a liquid channel: 1) on the individual battery cell are situated opposite one another, 2) on the individual battery cell, are situated diagonally opposite one another, 3) open out on the same side of the individual battery cell. Further it is possible to provide on an individual battery cell multiple fluidically separated liquid channels, quasi-separated liquid circuits. These in particular two liquid channels can be configured in such a manner that the inlet and outlet of a liquid channel open out on the one side of the individual battery cell, while the inlet and outlet of the other liquid channel open out on the other side of the individual battery cell. This one side and this other side of the individual battery cell can be practically arranged opposite one another. A battery device including two liquid channels can be operated either in counter-flow or in synchronized flow, wherein the inflows of the liquid channels are arranged on the same side of the battery device and the outflows of the liquid channels on the same side, in particular an opposite side of the battery device or that the inflows of the liquid channels are arranged on sides of the battery device that are opposite one another and the outflows of the liquid channels are likewise arranged on sides of the battery device that are opposite one another. This results in thermal advantages during the operation of the battery device.

In summary, it remains to note: The present disclosure relates to a battery device having a cell stack of rechargeable individual batteries that are touchingly stacked and clamped to one another in manner in a stack direction, in particular so-called hard case battery cells, wherein on at least one mounting surface of a cell housing comprising mounting surfaces of a respective individual cell battery arranged rectangularly at least one separate channel web for forming a liquid channel that can be flowed through is arranged. It is substantial for the disclosure that at least one of the respective channel webs is touchingly fixed in a firmly bonded manner to the respective mounting surface by bonding, preferentially with web adhesive.

Further features and advantages of the disclosure are obtained from the drawings and from the associated figure description by way of the drawings.

It is to be understood that the features mentioned above and still to be explained in the following cannot only be used in the respective combination stated, but also in other combinations or by themselves without leaving the scope of the present disclosure.

Exemplary embodiments of the disclosure are shown in the drawings and are explained in more detail in the following description, wherein same reference numbers relate to same or similar or functionally same components.

### BRIEF DESCRIPTION OF THE DRAWINGS

The disclosure will now be described with reference to the drawings wherein:

FIG. 1 shows a perspective view of a battery device according to an exemplary embodiment of the disclosure,

FIG. 2 shows a perspective view of a first version of an individual battery cell of the battery device shown in FIG. 1 with a view according to an arrow II shown in FIG. 1,

FIG. 3 shows, in a perspective view, a further version of an individual battery cell,

FIG. 4 shows a further version of an individual battery cell of the battery device in a greatly simplified, schematic plan view, wherein the channel webs arranged on this individual battery cell form multiple liquid channels that can be flowed through, and

FIG. 5 shows a further version of an individual battery cell of the battery device in a greatly simplified, schematic plan view, wherein the channel webs arranged on this individual battery cell form multiple liquid channels that can be flowed through.

### DESCRIPTION OF EXEMPLARY EMBODIMENTS

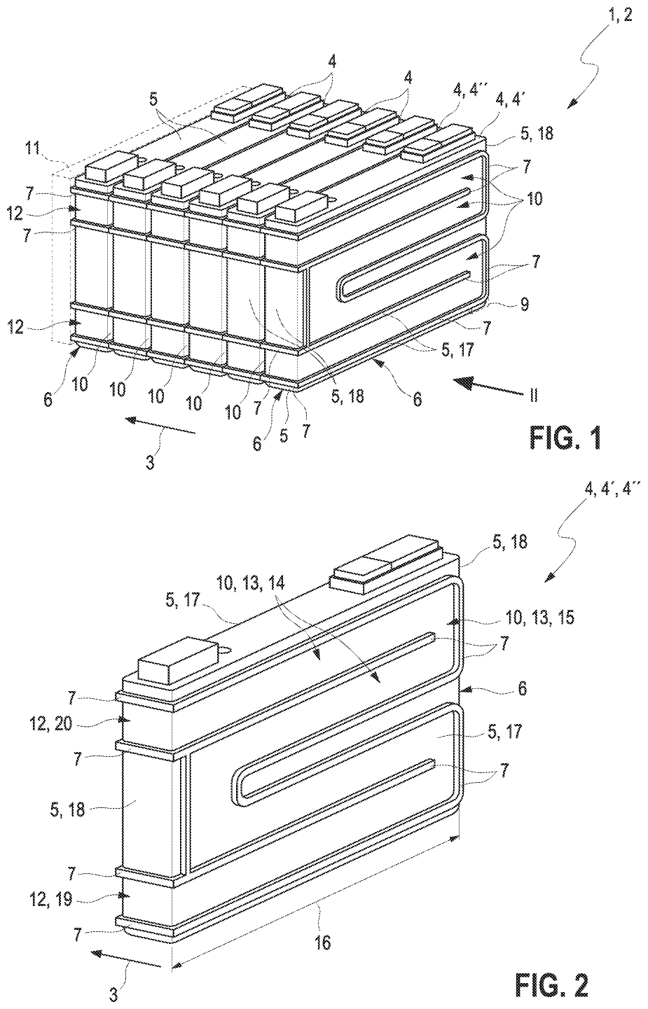

FIG. 1 shows a perspective view of a battery device designated with 1 as a whole, which comprises at least one cell stack 2 each of a plurality of rechargeable individual battery cells 4,4′,4″. The battery device 1 can form for example a traction battery device for a motor vehicle. The individual battery cells 4,4′,4″ are touchingly stacked to one another in a stack direction 3 indicated in FIG. 1 with an arrow and are non-displaceably clamped against one another both in the stack direction 3 and also transversely thereto. The cell stack 2 of individual battery cells 4,4′,4″ further defines two rectangular stack front faces not designated in more detail which are oriented opposite to one another in the stack direction 3, wherein on each of these stack front faces in principle an end plate designated with the reference number 11 each can be touchingly arranged. Here, merely a single end plate 11 is indicated with dotted line in FIG. 1.

In FIG. 1, it is noticeable, further, that on at least one planar mounting surface 5 of a cell housing 6 of a respective individual battery cell 4,4′,4″ substantially comprising six mounting surfaces 5 touchingly arranged against one another rectangularly, multiple separate contiguous channel webs 7 are arranged. Exemplarily, all channel webs 7 are touchingly fixed in a firmly bonded manner to the respective mounting surface 5 by bonding with a web adhesive and are each formed entirely of the web adhesive. In FIGS. 1 to 3, the respective web adhesive is shown in a hardened, not flowable state, i.e., stable in shape and following an application operation with an application robot that is not shown.

Furthermore, it is provided to arrange in the stack direction 3 between at least two adjacent cell housings 6 of two separate individual battery cells 4,4′,4″, at least one liquid channel 10 that can be flowed through for conducting liquid, wherein the channel web 7 or channel webs 7 form or delimit the respective liquid channel 10. This has the effect that between the separate individual battery cells 4,4′,4″ of the cell stack 2 liquid can flow, in particular transversely to the stack direction 3, in order to thus transfer heat energy from the individual battery cells 4,4′,4″ to the liquid, or vice versa. By way of this, the individual battery cells 4,4′,4″ of the cell stack 2 can either be cooled or heated at choice, for example in order to adjust suitable operating parameters of the individual battery cells 4,4′,4″. According to FIG. 1, all separate individual battery cells 4,4′,4″ are exemplarily equipped with channel webs 7 and are each indirectly touchingly stacked by way of two channel webs 7 touchingly supporting one another in the stack direction 3, wherein the channel webs 7 supported on one another form or delimit one or multiple liquid channels 10 for conducting liquid, in order to thereby advantageously cool and/or heat the battery device 1 as desired. Here, the one of the two channel webs 7 is fixed on a mounting surface 5 of a cell housing 6 of the one respective individual battery cell 4,4′ and the other channel web 7 on a mounting surface 5 of a directly adjacent cell housing 6 of the other respective individual battery cell 4,4″.

In order to reduce the pressure forces acting during the clamping of the individual battery cell 4,4′,4″ in the direction of the stack direction 3 on a respective channel web 7, at least one spacer 9 can be arranged on at least one mounting surface 5 of the respective cell housing 8 equipped with at least one channel web 7 of web adhesive. Such a spacer 9 is exemplarily indicated in FIG. 1 with a dashed line. The spacer or spacers 9 quasi act in a force-assisting manner and beside the channel webs 7 in the stack direction 3 so that pressure forces occurring during the clamping of the individual battery cells 4, 4′, 4″ to form a common cell stack 2 are absorbed both by the channel webs 7 and also by the spacers 9.

In FIG. 1, it is noticeable, further, that beside the explained channel webs 7 forming or delimiting the liquid channels 10, further channel webs 7 are present in order to form or delimit at least one collection channel 12 for discharging and supplying liquid to at least one of the respective liquid channels 10. By way of this, each liquid channel 10 of the cell stack 2 can be quasi advantageously supplied with liquid with a collection channel 12. Exemplarily, at least one liquid channel 10 and at least one collection channel 12 can be delimited or bordered transversely with respect to the stack direction 3 by a pair of channel webs 7.

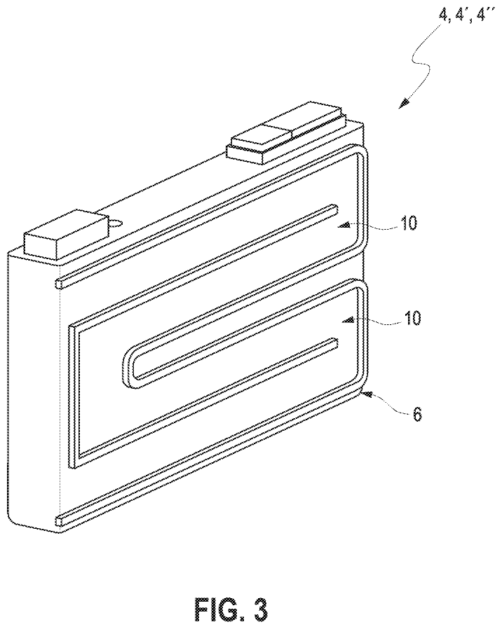

In FIG. 2, a first version of an individual battery cell 4, 4′, 4″ of the battery device 1 according to FIG. 1 with a view according to an arrow II entered in FIG. 1 is noticeable in a perspective view, wherein at least one shown liquid channel 10 has meandering channel loops 13. Each of the channel loops 13 has two meander long arms 14 and an arc-shaped meander short arm 15 connecting these to one another so as to communicate fluidically, wherein the respective meander long arms 14 are oriented transversely with respect to the stack direction 3. With respect to the stack direction 3 and the meander long arms 14, the meander short arm 15 is oriented transversely. As is noticeable, the respective meander short arm 15 extends over minimally 10% and maximally 30% of a total length 16 of a meander long arm 14. Flow-active patterns can be introduced into the liquid channel 10, for example winglets, V-winglets and round or oval structures, all of which serve for increasing the turbulences and/or the heat transfer and/or additionally the improvement of the support surfaces. These are not illustrated in FIG. 2.

With respect to the liquid channels 10 and collection channels 12 explained above, it still needs to be added that exemplarily each cell housing 6 of an individual battery cell 4, 4′, 4″ comprises at least two mounting surfaces 5 which are referred to as liquid channel mounting surfaces 17 and are located opposite one another, wherein these surfaces are exemplarily oriented perpendicularly with respect to the stack direction 3. Beside these liquid channel mounting surfaces 17 or mounting surfaces 5, each cell housing 6 of an individual battery cell 4, 4′, 4″ exemplarily comprises additionally at least two further mounting surfaces 5 each designated as collection channel mounting surface 18, which, here, are oriented parallel with respect to the stack direction 3 and at a right angle with respect to at least one of a liquid channel mounting surface 17 of the respective cell housing 6, as is noticeable in particular in FIG. 2. Further, multiple channel webs 7 are arranged on each liquid channel mounting surface 17 and in each case on at least one collection channel mounting surface 18, in order to form or delimit on the liquid channel mounting surfaces 17 the mentioned liquid channels 10 for conducting liquid, and in order to form or delimit on the collection channel mounting surface 18 or collection channel mounting surfaces 18 collection channels 12 for discharging and supplying liquid to at least one of the liquid channels 10. Here, the collection channels 12 can be practically flowed through by liquid longitudinally with respect to the stack direction 3. For temperature-controlling the battery device 1 it is provided that exemplarily all collection channels 12 are connected to all liquid channels 10 so as to communicate fluidically in order to supply the liquid channels 10 with liquid and in order to quasi-state a liquid system that can be flowed through by liquid, with which the battery device 1 can be cooled and/or heated as desired.

It has proved itself in practice to form at least one collection channel 12 as supply channel 19 for supplying liquid to one or all liquid channels 10 and a further collection channel 12 as discharge channel 20 for discharging liquid from one or all liquid channels 10, see FIG. 2. One can imagine for example to connect a supply line to the supply channel 19 and a discharge line to the discharge channel 20 so that liquid during the operation of the battery device 1 can, initially emanating from the supply line, flow through the supply channel 19 to the liquid channels 10. After the liquid has flowed through there quasi in a heat energy-transferring manner through the meandering channel loops 13 of the respective liquid channels 10, it can, downstream, enter the discharge channel 20 and the discharge line in order to flow out there. The practical work with the battery device 1 can thus be favored.

FIG. 3 shows in a perspective view a further version of an individual battery cell 4, 4′, 4″, which can be exemplarily incorporated in a cell stack 2 of a battery device 1 according to the above description. In contrast with the individual battery cells 4, 4′, 4″ according to the first version in accordance with the above description, the individual battery cells 4, 4′, 4″ are each equipped merely with multiple liquid channels 10 arranged on the respective cell housing 6 according to the further version according to FIG. 3, while collection channels 12 have been omitted. In this liquid channel 10, flow-active patterns can also be introduced which are not shown in FIG. 3, for example winglets, V-winglets and round or oval structures, which altogether serve for increasing the turbulences and/or the heat transfer and/or additionally for the improvement of the support surfaces.

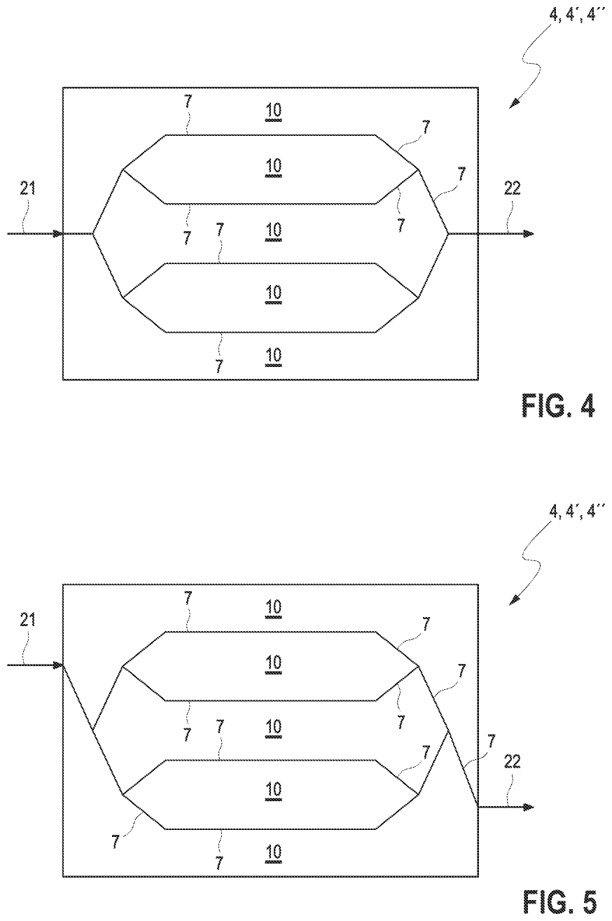

FIG. 4 shows a further version of an individual battery cell 4, 4′, 4″ of the battery device 1 in a highly simplified, schematic plan view, wherein the channel webs 7 arranged on this individual battery cell 4, 4′, 4″ form multiple liquid channels 10 that can be flowed through, which are configured branched and parallel to one another at least in portions. It is noticeable, furthermore, that the liquid channels 10 have a common inflow 21 and a common outflow 22 which on the individual battery cell 4, 4′, 4″ are arranged opposite one another, i.e., the liquid flowing through the liquid channels 10 flows quasi from “the left” into the liquid channels 10 and “on the right” out of the same. Practically, two to six of such parallel liquid channels 10 are provided.

FIG. 5 shows, like FIG. 4, multiple liquid channels 10 that are parallel to one another, whose common inflow 21 and common outflow 22 are arranged on the individual battery cell 4, 4′, 4″ opposite one another. In contrast with the inflow 21 and outflow 22 illustrated in FIG. 4, it is provided here however that the inflow 21 and outflow 22 are arranged on the individual battery cell 4, 4′, 4″ diagonally opposite one another, i.e., so that the liquid flowing through the liquid channels 10 quasi flows from “the top left” into the liquid channels 10 and “at the bottom right” out of the same.

The liquid channels 10 shown in FIGS. 4 and 5 can form a bionic channel arrangement. Here it is possible that the flow direction of the liquid flowing into the liquid channel 10, in particular, at the inflow 21, is either equal to or opposite to the flow direction of the liquid flowing out of this liquid channel 10, in particular at the outflow 22.

It is understood that the foregoing description is that of the exemplary embodiments of the disclosure and that various changes and modifications may be made thereto without departing from the spirit and scope of the disclosure as defined in the appended claims.

What is claimed is:

1. A battery device, comprising:
a cell stack of rechargeable individual battery cells stacked and clamped to one another in a stack direction,
wherein on at least one mounting surface of a cell housing of a respective individual battery cell comprising mounting surfaces arranged rectangularly, at least one separate channel web for forming a liquid channel that can be flowed through is arranged, and
wherein at least one of these channel webs is touchingly fixed in a firmly bonded manner to the respective mounting surface by bonding.

2. The device according to claim 1, wherein at least one of these channel webs is at least partially formed by a web adhesive and which in the hardened state of the web adhesive is stable in shape.

3. The device according to claim 1, wherein:
the web adhesive forming the respective channel webs originates from the group of the thixotropic adhesives, and/or
the web adhesive forming the respective channel webs has thixotropic properties.

4. The device according to claim 1, wherein on at least one mounting surface of the respective cell housing equipped with at least one channel web of web adhesive, at least one spacer is arranged, which beside the respective at least one channel web has a force-supporting effect in the stack direction.

5. The device according to claim 1, wherein at least one filler, in particular glass spheres or glass hollow spheres, is admixed to the respective web adhesive.

6. The device according to claim 1, wherein:
at least two separate individual battery cells of the cell stack are indirectly touchingly stacked to one another via a single channel web in the stack direction, the respective channel web forms or delimits at least one liquid channel for conducting liquid, and the respective channel web is fixed on the cell housing of the one respective individual battery cell or on the cell housing of the other respective individual battery cell, and/or
flow-active patterns such as winglets and/or V-winglets and/or round and/or oval structures are introduced into the liquid channel.

7. The device according to claim 1, wherein:
at least two separate individual battery cells of the cell stack are indirectly touchingly stacked onto one another via two channel webs in the stack direction, these two channel webs jointly form or delimit at least one liquid channel for conducting liquid and the one channel web is fixed on the cell housing of the one respective individual battery cell and the other channel web on the cell housing of the other respective individual battery cell, and/or
in the stack direction, between a cell housing of an individual battery cell of the cell stack and an end plate arranged at the front face on the cell stack, at least one liquid channel formed of channel webs for conducting liquid is formed or delimited.

8. The device according to claim 1, wherein:
at least two separate individual battery cells of the cell stack are indirectly touchingly stacked to one another via channel webs in the stack direction,
the respective channel webs form or delimit at least one liquid channel for conducting liquid, and
further channel webs form or delimit at least one collection channel for discharging and supplying liquid from/to at least one respective liquid channel.

9. The device according to claim 6, wherein:
at least one liquid channel comprises meandering channel loops,
at least one channel loop has meander long arms and an arc-shaped meander short arm connecting these to one another so as to communicate fluidically,
the respective meander long arms are oriented transversely with respect to the stack direction,
the respective meander short arm is oriented transversely with respect to the stack direction and the meander long arms, and
the respective meander short arm extends over maximally 30% of a total length of a meander long arm.

10. The device according to claim 6, wherein:
at least one liquid channel and/or at least one collection channel is delimited or bordered transversely with respect to the stack direction by at least one channel web or a pair of channel webs, in order to conduct liquid for cooling or heating the individual battery cells.

11. The device according to claim 1, wherein:
at least one mounting surface of the respective cell housing designated as liquid channel mounting surface is oriented perpendicularly or substantially perpendicularly with respect to the stack direction, and
the respective cell housing comprises two liquid channel mounting surfaces which are located opposite one another and are oriented parallel to one another.

12. The device according to claim 11, wherein:
at least one mounting surface of the respective cell housing designated as collection channel mounting surface is oriented parallel or substantially parallel with respect to the stack direction, and
at least one collection channel mounting surface of the respective cell housing is arranged at a right angle with respect to at least one liquid channel mounting surface of the respective cell housing.

13. The device according to claim 12, wherein:
channel webs are each arranged on at least one liquid channel mounting surface and on at least one collection channel mounting surface each,
the channel webs arranged on the liquid channel mounting surfaces form or delimit liquid channels for conducting liquid and the channel webs arranged on the collection channel mounting surfaces form or delimit collection channels for discharging and supplying liquid from/to at least one of the liquid channels.

14. The device according to claim 1, wherein at least one collection channel for discharging and supplying liquid is connected to at least one liquid channel so as to communicate fluidically.

15. The device according to claim 1, wherein a collection channel is configured as supply channel for supplying liquid to one or all liquid channels and a further collection channel as a discharge channel for discharging liquid from one or all liquid channels.

16. A method for producing a battery device including at least two rechargeable individual battery cells, the method comprising:
(1a) Applying an adhesive forming an adhesive bead, in particular a web adhesive from the group of the thixotropic adhesives, to a mounting surface (5) of a first individual battery cell (4,4′) with an application robot or as part of a screen print or as part of a stencil print with guide stencils; or
(1b) applying an adhesive enriched with fillers and forming an adhesive bead, in particular a web adhesive from the group of the thixotropic adhesives to a mounting surface of a first individual battery cell with the help of an application robot or as part of a screen print or as part of a stencil print with guide stencils; or
(2a) applying an adhesive forming an adhesive bead, in particular a web adhesive from the group of the thixotropic adhesives to a mounting surface of a second individual battery cell with the help of an application robot or as part of a screen print or as part of a stencil print with guide stencils; or
(2b) applying an adhesive enriched with fillers and forming an adhesive bead, in particular a web adhesive from the group of the thixotropic adhesives to a mounting surface of a second individual battery cell with the help of an application robot or as part of a screen print or as part of a stencil print with guide stencils;
(3) Hardening of the respective adhesives in order to form channel webs that are stable in shape out of the applied adhesive beads;
(4) stacking the two individual battery cells to one another in a stack direction, wherein the channel webs of the first individual battery cell each touchingly support themselves on the channel webs of the second individual battery cell, in order to form between the two individual battery cells liquid channels that can be flowed through by liquid for the purpose of individual battery cell temperature control, and/or
(5) optionally carrying out an intermediate Step (3a) to be carried out between Step (3) and (4) according to which, following the hardening of the adhesives forming the respective channel webs, a further adhesive is applied to these hardened channel webs and the stacking to one another according to Step (4) then carried out.
